(19) United States
(12) Patent Application Publication
(10) Pub. No.: US 2006/0153655 A1
(43) Pub. Date: Jul. 13, 2006

(54) Machine tool having a C-shaped frame

(75) Inventors: Tai-Kun Chang, Taichung City (TW); Horng-Jade Jan, Taichung City (TW)

Correspondence Address: HAMRE, SCHUMANN, MUELLER & LARSON, P.C., P.O. BOX 2902-0902, MINNEAPOLIS, MN, 55402, US

(73) Assignee: SUEN CIN ENTERPRISE CO., LTD., Taichung City (TW)

(21) Appl. No.: 11/110,441

(22) Filed: Apr. 20, 2005

(30) Foreign Application Priority Data
Jan. 7, 2005 (TW) 094200366

(51) Int. Cl. B23C 1/06

(52) U.S. Cl. 409/235

(57) ABSTRACT

A machine tool includes a C-shaped frame having a machine bed and an upright frame portion. A carrier is movable on the machine bed along a first direction. A worktable unit includes a base movable on the carrier along a second direction perpendicular to the first direction, and a rotating seat disposed rotatably on the base. A workpiece can be held on the rotating seat. A machine head unit is movable relative to the upright frame portion along a third direction perpendicular to the first and second directions. The machine head unit includes a main spindle rotatable about a rotating axis that is spaced apart from the upright frame portion of the C-shaped frame by a distance smaller than the maximum travel of the worktable unit.

### CROSS-REFERENCE TO RELATED APPLICATION

This application claims priority of Taiwanese Application No. 094200366, filed on Jan. 7, 2005.

### BACKGROUND OF THE INVENTION

1. Field of the Invention

This invention relates to a machine tool, and more particularly to a machine tool that has a C-shaped frame and that is suitable for machining a workpiece that is symmetrical about its central axis.

2. Description of the Related Art

Referring to FIGS. 1 and 2, a conventional machine tool includes a C-shaped frame that has a machine bed 101 and an upright frame portion 102. The machine tool further includes a carrier 2 movable on the machine bed 101 along a first direction (Y), a worktable unit 3 movable on the carrier 2 along a second direction (X) perpendicular to the first direction (Y), and a machine head unit 4 movable on the upright frame portion 102 along a third direction (Z), which is perpendicular to the first and second directions (Y, X). The worktable unit 3 can hold a workpiece (not shown), such as a wheel rim. The machine head unit 4 includes a main spindle 401 having a rotating axis that is spaced apart from the upright frame portion 102 by a distance (L1). The distance (L1) is greater than the maximum travel of the worktable unit 3, which is indicated by a distance (L2). Because the distance (L1) is large, the rotating axis of the main spindle 401 is apt to tilt or otherwise become misaligned. If this occurs, the machining accuracy of the machine tool is reduced.

Furthermore, to prevent the workpiece from contact with the upright frame portion 102, the upright frame portion 102 is formed with a recess 103, into which, the workpiece may move. However, due to the presence of the recess 103, the structural strength of the upright frame portion 102 is reduced.

### SUMMARY OF THE INVENTION

The object of this invention is to provide a machine tool that has a C-shaped frame and that is capable of overcoming the above-mentioned disadvantages associated with the prior art.

According to this invention, a machine tool is provided for machining a workpiece, and includes a C-shaped frame having a machine bed and an upright frame portion. A carrier is movable on the machine bed along a first direction. A worktable unit includes a base movable on the carrier along a second direction perpendicular to the first direction, and a rotating seat disposed rotatably on the base. The workpiece can be held on the rotating seat such that the rotating seat is rotatable about the central axis of the workpiece. A machine head unit is movable relative to the upright frame portion along a third direction perpendicular to the first and second directions. The machine head unit includes a main spindle rotatable about a rotating axis that is spaced apart from the upright frame portion of the C-shaped frame by a distance smaller than the maximum travel of the base.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional machine tool having a C-shaped frame;

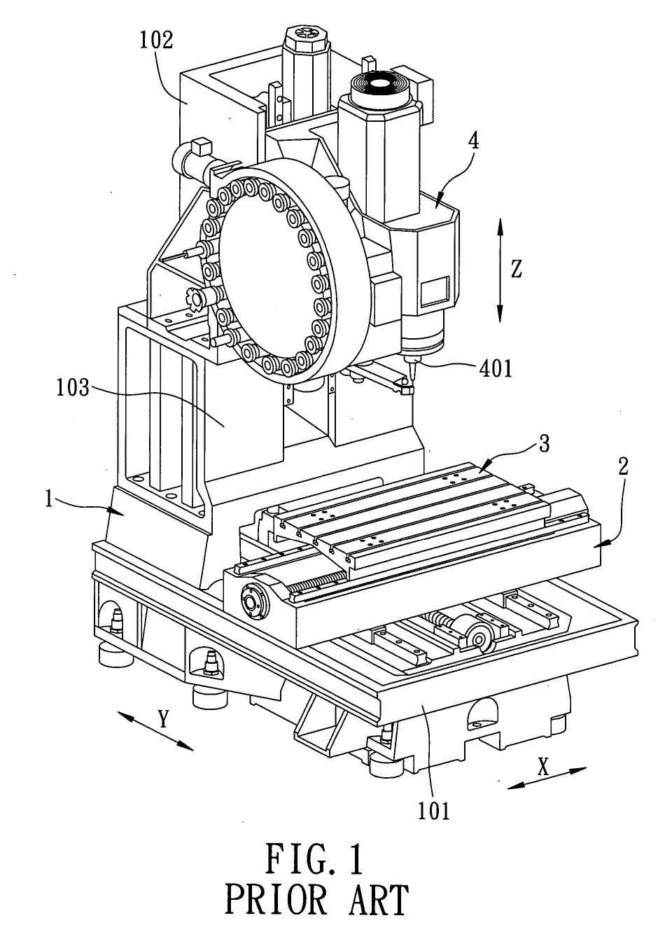

FIG. 2 is a side view of the conventional machine tool;

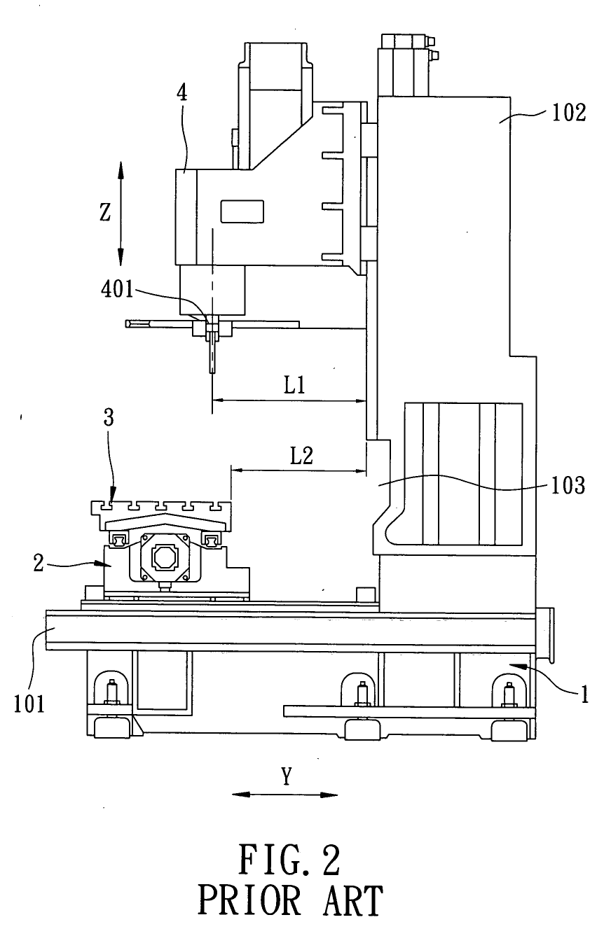

FIG. 3 is a side view of the preferred embodiment of a machine tool according to this invention;

FIG. 4 is a front view of the preferred embodiment;

FIG. 5 is a perspective view of a worktable unit of the preferred embodiment; and

FIG. 6 is a fragmentary sectional view of a rotating seat of the worktable unit of the preferred embodiment, illustrating how a workpiece is held on the rotating seat.

### DETAILED DESCRIPTION OF THE PREFERRED EMBODIMENT

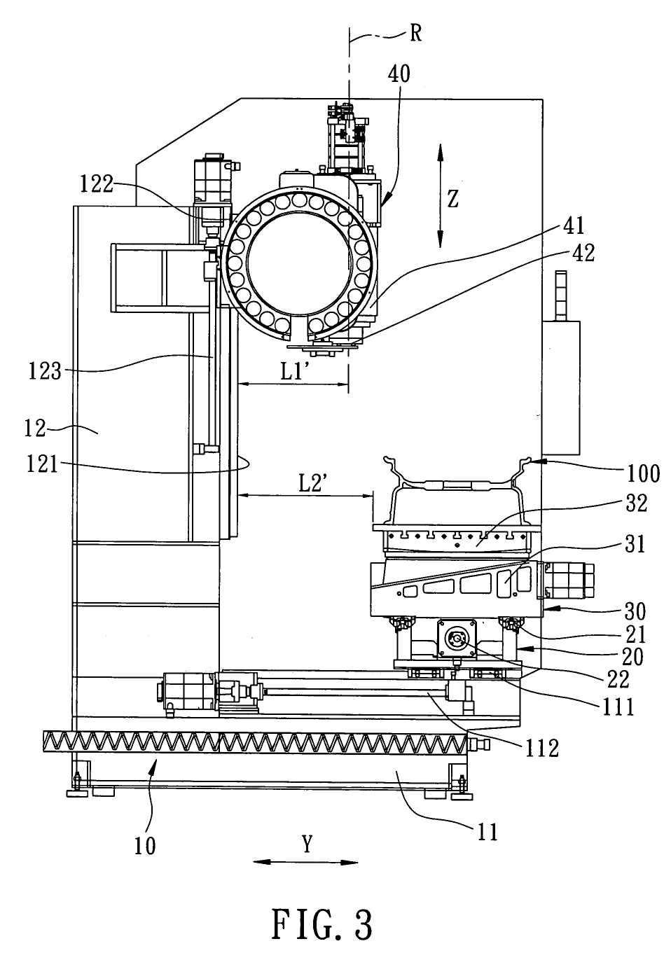

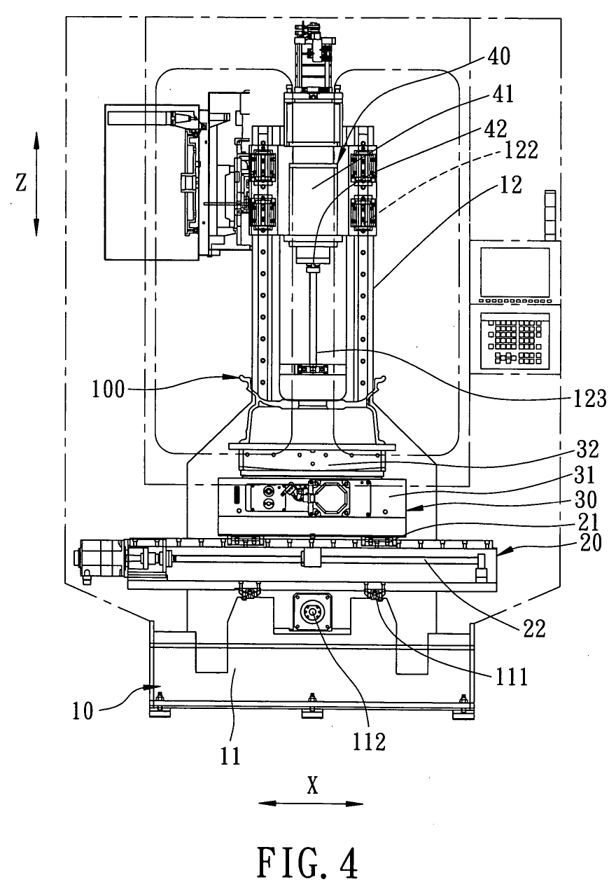

Referring to FIGS. 3 and 4, the preferred embodiment of a machine tool according to this invention is suitable for machining a workpiece 100, such as a wheel rim, which has a central axis (C) and which is symmetrical about the central axis (C). The machine tool includes a C-shaped frame 10, a carrier 20, a worktable unit 30 and a machine head unit 40.

The C-shaped frame 10 has a machine bed 11 and an upright frame portion 12 that is fixed on the machine bed 11 at a lower end thereof. The machine bed 11 includes two Y-directional slide rails 111 disposed on a top surface thereof, and a threaded Y-directional guiding rod 112 disposed between the Y-directional slide rails 111. The upright frame portion 12 includes a front side surface 121, two Z-directional slide rails 122 disposed on the front side surface 121, and a threaded Z-directional guiding rod 123 disposed between the Z-directional slide rail units 122.

The carrier 20 is disposed movably on the Y-directional slide rails 111, and is driven by the Y-directional guiding rod 112 to move on the machine bed 11 along a first direction (Y). The carrier 20 includes two X-directional slide rails 21 and a threaded X-directional guiding rod 22 disposed between the X-directional slide rails 21.

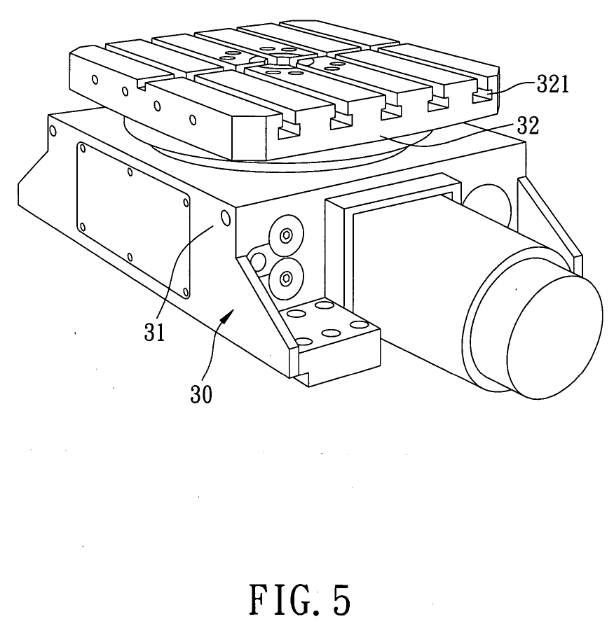

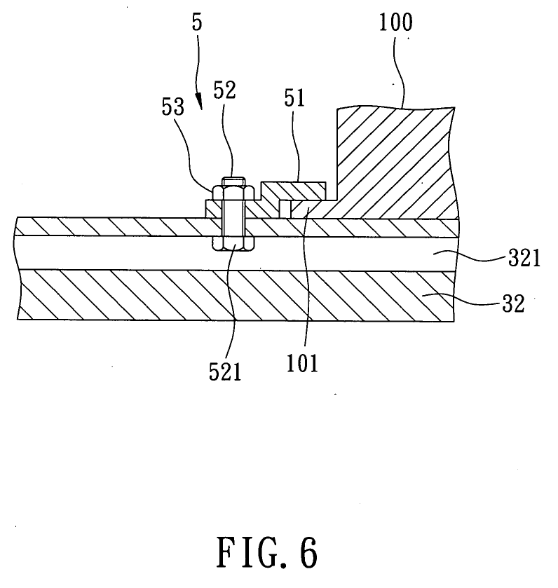

The worktable unit 30 includes a base 31 and a rotating seat 32 disposed rotatably on the base 31. The base 31 is disposed movably on the X-directional slide rails 21, and is driven by the X-directional guiding rod 22 to move on the carrier 20 along a second direction (X) perpendicular to the first direction (Y). Referring to FIGS. 5 and 6, the workpiece 100 has an outward flange 101 that extends radially and outwardly from a lower end thereof. The outward flange 101 is locked on the rotating seat 32 by a plurality of locking units 5 (only one is shown in FIG. 6), each of which includes a zigzag holding member 51, a lock bolt 52 and a nut 53. The rotating seat 32 is formed with a plurality of dovetail grooves 321. Each of the holding members 51 is connected fixedly to the rotating seat 32 by the corresponding lock bolt 52 and the corresponding nut 53. Each of the lock bolts 52 has a head 521 disposed within the corresponding dovetail groove 321, and extends through the corresponding holding member 51 to engage the corresponding nut 53. The outward flange 101 of the workpiece 100 is clamped between the rotating seat 32 and the holding members 51. The workpiece 100 is held on the rotating seat 32 at a position such that the rotating seat 32 is rotatable about the central axis (C) of the workpiece 100.

Referring again to FIGS. 3 and 4, the machine head unit 40 includes a main seat 41 and a main spindle 42 journalled on the main seat 41. The main seat 41 is disposed movably on the Z-directional slide rails 122, and is driven by the Z-directional guiding rod 123 to move on the upright frame portion 12 along a third direction (Z) perpendicular to the first and second directions (Y, X). The main spindle 42 is rotatable about a rotating axis (R). The rotating axis (R) is spaced apart from the front side surface 121 of the upright frame portion 12 by a distance (L1′) that is smaller than the maximum travel of the worktable unit 30, which is indicated by a distance (L2′).

Because there is a reduction of the distance (L1′), as compared to the prior art, any deviation in the intended positioning of the rotating axis (R) of the main spindle 42 can be decreased. This increases the machining accuracy of the machine tool.

Although the distance (L1′) is small, any portion of the workpiece 100 can be machined because the rotating seat 32 and, therefore, the workpiece 100 can be rotated relative to the C-shaped frame 10. Furthermore, it is not necessary to form a recess in the upright frame portion 12. As such, the structural strength of the upright frame portion 12 is preserved.

With this invention thus explained, it is apparent that numerous modifications and variations can be made without departing from the scope and spirit of this invention. It is therefore intended that this invention be limited only as indicated by the appended claims.

I claim:

1. A machine tool for machining a workpiece, the workpiece having a central axis and being symmetrical about the central axis, said machine tool comprising:
a C-shaped frame having a machine bed and an upright frame portion that is fixed on said machine bed at a lower end thereof;
a carrier movable on said machine bed along a first direction;
a worktable unit including a base movable on said carrier along a second direction perpendicular to said first direction, and a rotating seat disposed rotatably on said base and adapted to hold the workpiece thereon such that said rotating seat is rotatable about the central axis of the workpiece; and
a machine head unit movable relative to said upright frame portion along a third direction perpendicular to said first and second directions, said machine head unit including a main spindle rotatable about a rotating axis, said rotating axis being spaced apart from said upright frame portion of said C-shaped frame by a distance that is smaller than a maximum travel of said worktable unit.
